(19) United States
(12) Patent Application Publication
(10) Pub. No.: US 2021/0206307 A1
(43) Pub. Date: Jul. 8, 2021

(54) TRUCK RAMP SYSTEM AND METHOD

(71) Applicant: Brooke Martinson, Maple Valley, WA (US)

(72) Inventor: Brooke Martinson, Maple Valley, WA (US)

(21) Appl. No.: 17/143,300

(22) Filed: Jan. 7, 2021

Related U.S. Application Data
(60) Provisional application No. 62/958,284, filed on Jan. 7, 2020.

(51) Int. Cl. B60P 1/43

(52) U.S. Cl. CPC B60P 1/431

(57) ABSTRACT

A ramp system for use with a vehicle is provided. The vehicle may include a truck with a truck bed or other types of vehicles. The ramp system includes a ramp structure held within a ramp support structure. The ramp support structure is configured with the vehicle and the ramp structure is able to transition from a retracted position within the ramp support structure (while not in use) to a deployed position outside the ramp support structure (while in use). In the deployed position, the ramp structure is held in an angled configuration extending from the back of the truck bed to the ground. In this way, the ramp structure may be deployed to enable heavy items to be loaded into the truck bed and stowed away when not in use. The ramp structure also may include legs configured to hold the ramp structure in a substantially horizontal position when deployed for use as a table or other type of platform.

### CROSS-REFERENCE TO RELATED APPLICATIONS

This application is a non-provisional application which claims priority to U.S. Provisional Patent Application No. 62/958,284 filed on Jan. 7, 2020, which is incorporated by reference in its entirety for any purpose.

### FIELD OF THE INVENTION

This invention relates to ramps, including ramps configured with a truck for use in loading and unloading items into and out of the truck's bed.

### BACKGROUND

Pickup trucks are designed to carry and haul large and/or heavy items. However, because the bed of a typical pickup truck is elevated 2-3 feet off the ground, large and heavy items may be difficult to load into the trucks.

One solution for this is to use a loading dock that is level with the bed of the truck such that the heavy and/or large items may be moved directly from the loading dock into the truck's bed. However, loading docks are typically only available at specific locations (e.g., warehouses) and are not available for most circumstances.

Another solution is to use a portable loading ramp that extends from the ground into the bed of the truck. However, portable loading ramps are typically stored within the bed of the truck thus taking up space that may be needed for other items. In addition, because mobile loading ramps are large and heavy, it can be difficult to place the mobile loading ramp into the truck's bed when it is needed and to subsequently remove it when not needed to free up space for other items. Portable loading ramps are also at risk for theft because they are easily visible and removable.

Accordingly, there is a need for a loading ramp that is integrated with a truck without reducing the amount of available space within a truck's bed. There is also a need for a loading ramp that is easily deployed from the truck when needed and stowed back into the truck when not.

### BRIEF DESCRIPTION OF THE DRAWINGS

Various other objects, features, and attendant advantages of the present invention will become fully appreciated as the same becomes better understood when considered in conjunction with the accompanying drawings, in which like reference characters designate the same or similar parts throughout the several views, and wherein:

FIG. 1 illustrates a rear view of a truck with a truck ramp system stowed away on the truck according to exemplary embodiments hereof;

FIG. 2 illustrates a top view of a truck with a truck ramp system stowed away on the truck according to exemplary embodiments hereof;

FIG. 3 illustrates a front perspective view of a ramp structure according to exemplary embodiments hereof;

FIG. 4 illustrates a front perspective view of a ramp structure including two ramp sections according to exemplary embodiments hereof;

FIG. 5 illustrates aspects of a ramp support structure according to exemplary embodiments hereof;

FIG. 6 illustrates aspects of a ramp support structure according to exemplary embodiments hereof;

FIG. 7 illustrates a front perspective view of a ramp system according to exemplary embodiments hereof;

FIG. 8 illustrates a front perspective view of a ramp system according to exemplary embodiments hereof;

FIGS. 9A-9C show aspects of a truck ramp system during deployment according to exemplary embodiments hereof;

FIGS. 10A-10B show aspects of a truck ramp system according to exemplary embodiments hereof;

FIGS. 11-13 show aspects of a truck ramp system configured with a truck according to exemplary embodiments hereof;

FIGS. 14-17 show aspects of a truck ramp system deployed from a truck according to exemplary embodiments hereof; and

FIGS. 18A-18B show aspects of a truck ramp system and leg support assembly according to exemplary embodiments hereof.

### DETAILED DESCRIPTION OF EXEMPLARY EMBODIMENTS

In general, the system according to exemplary embodiments hereof provides a ramp adapted to be configured with a truck (e.g., the bed of a pickup truck). The ramp is stored within the volume of the truck when not in use and is easily deployed from the truck for use in loading items into the truck's bed. When no longer needed, the ramp is then easily retracted and stored away back into the truck.

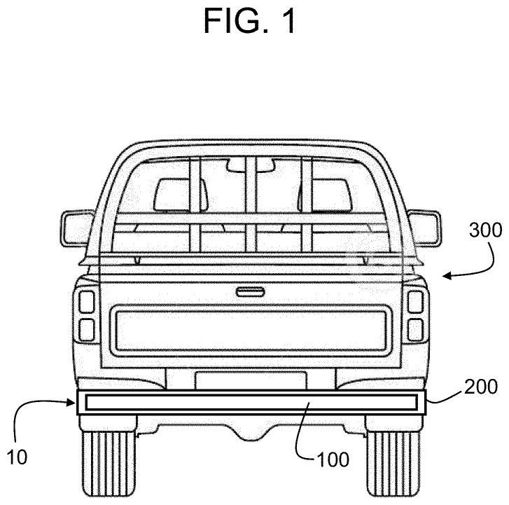

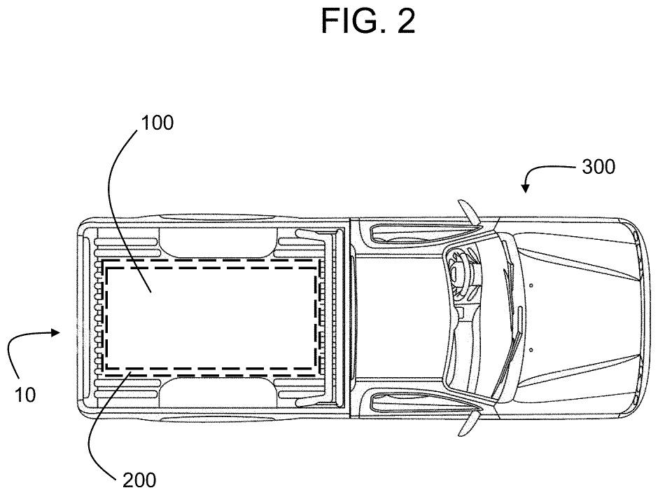

In one exemplary embodiment as shown in FIGS. 1 and 2, the ramp system 10 includes a ramp structure 100 and a support structure 200. In general, the ramp structure 100 is supported by the support structure 200, and the support structure 200 is configured with a truck 300 (e.g., a pickup truck). The support structure 200 supports the ramp structure 100 during its storage within the truck 300, during its deployment and use, and during its subsequent retraction (stowing) back into the truck 300. The system 10 may include other elements and components as necessary for it to fulfill its functionalities.

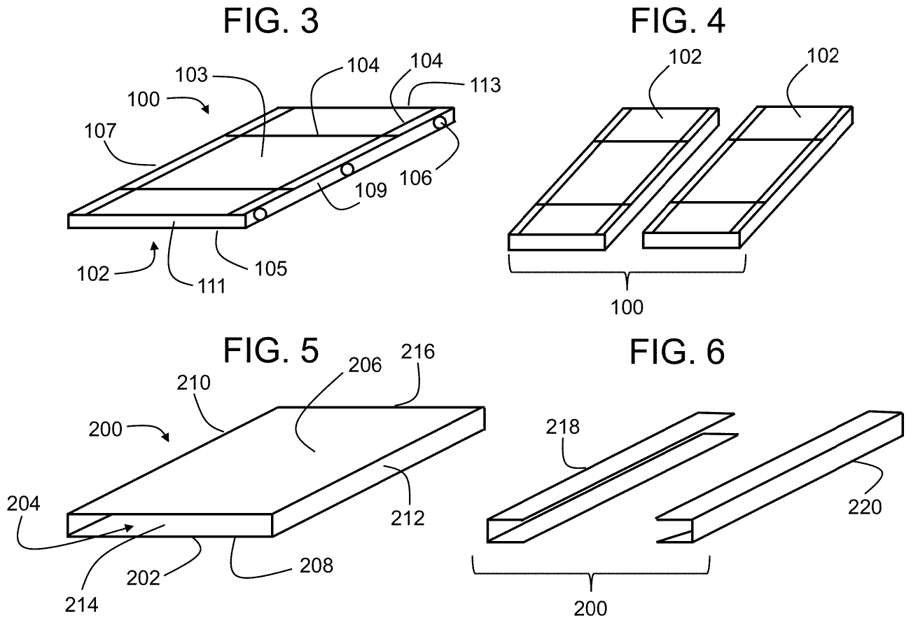

As shown in FIG. 3, the ramp structure 100 includes a ramp section 102 that when properly configured forms a ramp. The ramp section 102 may be rectangular and/or include other shapes and/or forms and may comprise metal, wood, composite materials (e.g., carbon fiber composite), any polymer, other types of materials, and any combination thereof. It is preferable that the section 102 be sufficiently strong and able to withstand a large amount of weight when used as a ramp. For example, the section 102 may preferably withstand 0-2000 pounds (or more) without deforming, bending, breaking, or becoming otherwise mechanically compromised.

In some embodiments, the ramp section 102 includes a top 103, a bottom 105, a left side 107, a right side 109, a front 111 and a back 113.

In some embodiments, the ramp section 102 may be solid and continuous. In some embodiments, the ramp section 102 may include cutouts that pass completely and/or partially through the section 102 in order to reduce the overall weight of the section 102. However, it is understood that the cutouts may not adversely compromise the overall strength of the ramp structure 100 and that the strength of the ramp structure 100 with the cutouts is within its documented specifications.

In some embodiments, the ramp section 102 includes reinforcement structures 104 such as ribs, beams, spines, other types of reinforcement structures, and any combination thereof. The reinforcement structures 104 may be oriented longitudinally, laterally, at any angle, and any combination thereof In general, the reinforcement structures 104 may sufficiently reinforce the rectangular ramp section 102 while keeping the overall weight of the ramp section 102 to a minimum.

In some embodiment hereof, the ramp section 102 includes one or more movement mechanisms 106 adapted to engage with the support structure 200 to facilitate the movement of the ramp section 102 in and out of the support structure 200. The movement mechanisms 106 may comprise rollers, wheels, bearings, continuous tracks, rails, pins, other types of movement mechanisms, and any combination thereof. The movement of the ramp section 102 with respect to the support structure 200 will be described further below.

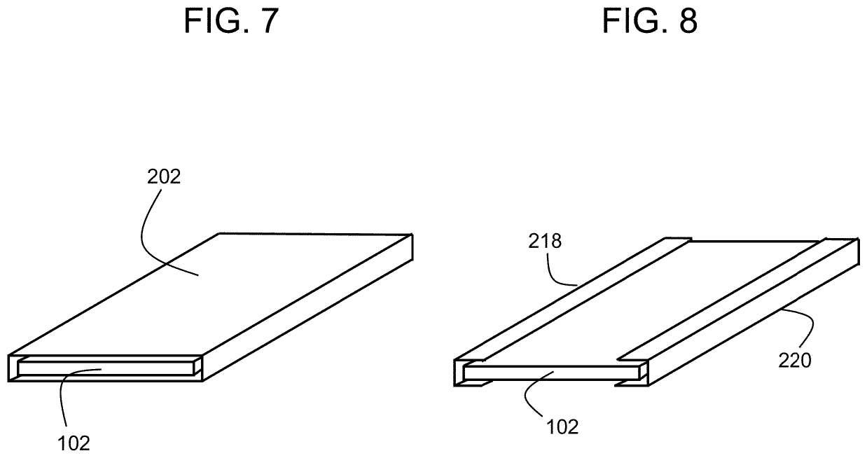

In some embodiments, the ramp structure 100 may comprise two or more ramp sections 102 as shown in FIG. 4. In one embodiment, the two or more ramp sections 102 may be generally side-by-side in a parallel configuration. In other embodiments, the two or more ramp sections 102 may be at offset angles. It is understood that the two or more ramp sections 102 may be placed at any orientation with respect to one another in order for the two or more ramp sections 102 to form the desired ramp structure 100.

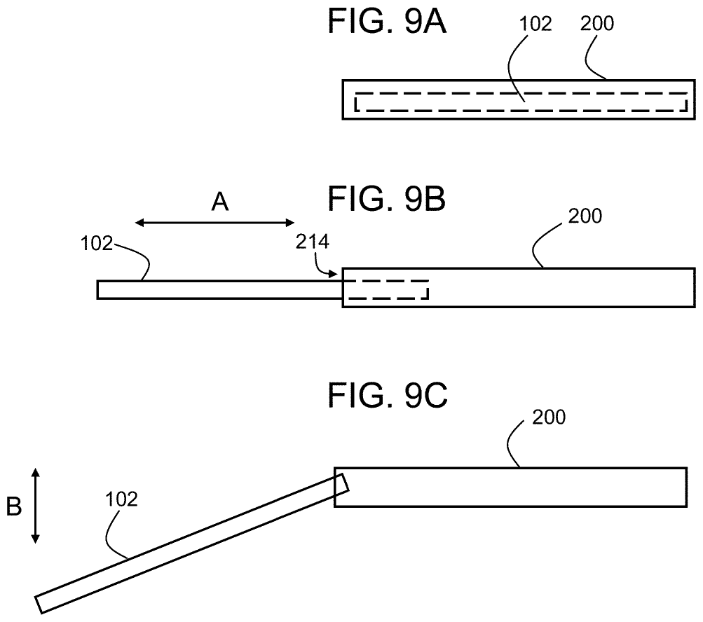

In one exemplary embodiment hereof as shown in FIG. 5, the support structure 200 includes a housing 202 with an inner volume 204 adapted to receive and support the ramp structure 100. In some embodiments, the housing 202 includes a top side 206, a bottom side 208, a left side 210, a right side 212, a front side 214 and a back side 216 that together define the inner volume 204. In some embodiments, the front side 214 and/or the back side 216 may be open or closed. If the front side 214 is closed, the front 214 may be opened to allow access to the inner volume 204 of the housing 202. This will be described in other sections.

In addition to providing protection to the ramp structure 100 contained within, the housing 202 acts as a track, rail and/or guide to support the ramp section 102 and to facilitate its movement in and out of the housing 202 as necessary (e.g., for deployment and/or stowing). This will be described in other sections.

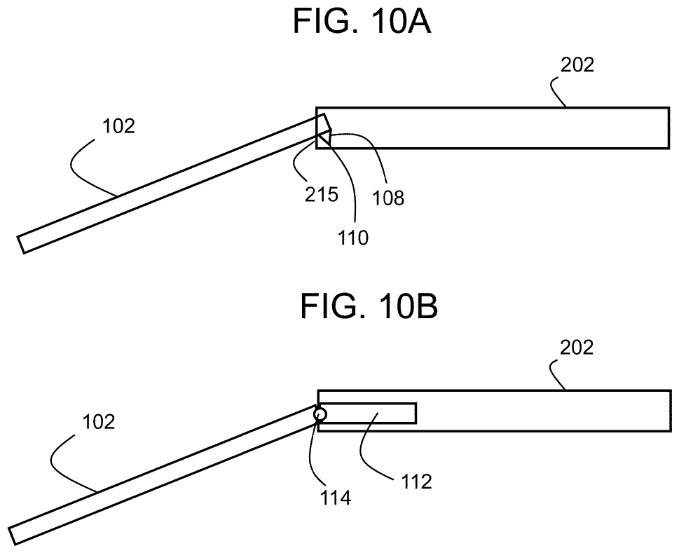

An alternative embodiment of the support structure 200 is shown in FIG. 6. In this embodiment, the support structure 200 includes a left support 218 and a right support 220. In some embodiments, the left support 218 may resemble the left portion of the housing 202 of FIG. 2, and the right support 220 may resemble the right portion of the housing 202 of FIG. 2. In this way, similar to the housing 202, the left and right supports 218, 220 each act as a track or guide to support the ramp structure 100 and to facilitate its movement in and out of the housing 202. This will be described in other sections.

A person of ordinary skill in the art will understand, upon reading this specification, that the example architectures of the support structure 200 described above are for demonstration and that the support structure 200 may include other architectures that support the ramp section 102 and facilitate its movement in and out of the support structure 200. For example, the support structure 200 may include longitudinal slots in its left and right sides 210, 212 within which the movement mechanisms 106 may engage. In other examples, tracks, rails, racks, beams, or other types of support and/or guidance structures may be used. In some embodiments, the support structure 200 may support the ramp structure's movement mechanisms 106 (if present), the body of the ramp structure 106 or any combination thereof.

In any of the embodiments, the support structure 200 may comprise metal, wood, composite materials (e.g., carbon fiber composite), any polymer, other types of materials, and any combination thereof.

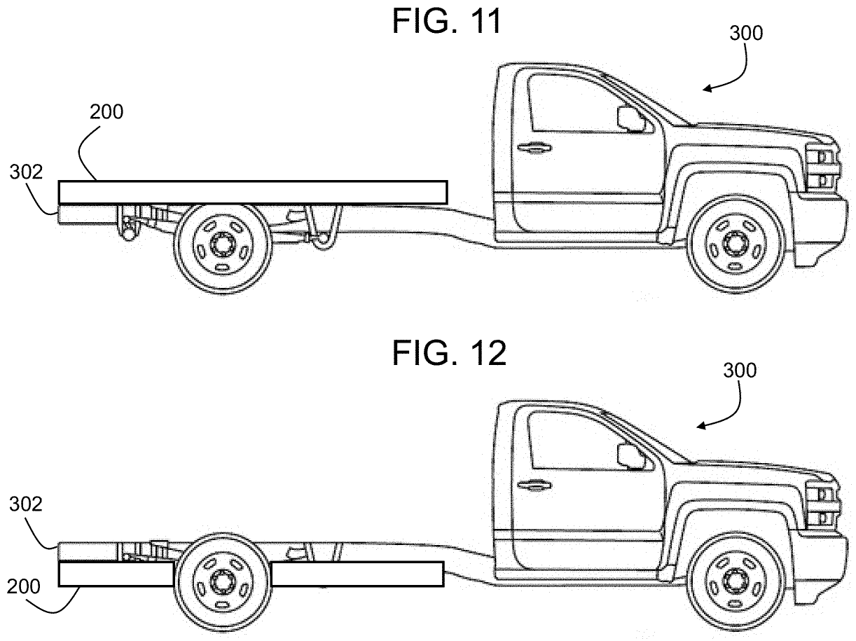

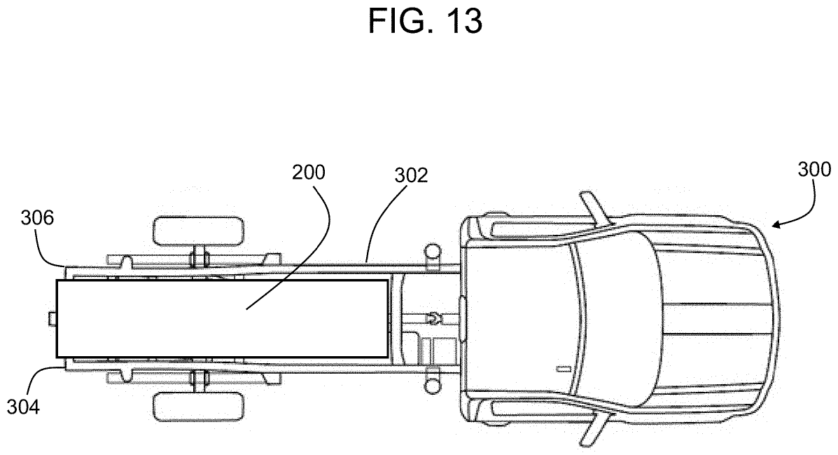

FIG. 7 shows the ramp structure 100 received and supported within the housing's inner volume 204 and FIG. 8 shows the ramp section 102 received and supported by the housing's left and right supports 218, 220.

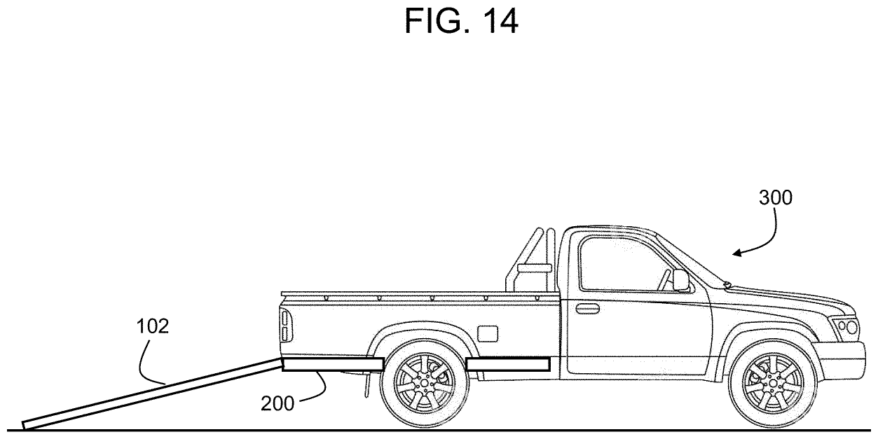

FIG. 9A shows the ramp section 102 received into and supported within the inner volume of the support structure 200. As shown in FIG. 9B, the ramp section 102 may move in and out of the front 214 of the support structure 200 as represented by the arrow A. In some embodiments, the movement is facilitated by the movement mechanisms 106 (if present) engaging with the housing 202 and/or the left and right supports 218, 220.

When deployed for use as a ramp, the ramp structure 100 may pivot downward so that its front may rest on the ground surface. In this configuration, the front of the ramp section 102 rests on the ground surface and the back of the ramp section 102 is supported by the front of the support structure 200 (e.g., the front 214 of the housing 202). When not in use and ready to be stowed, the ramp section 102 may pivot upward and back into the generally horizontal position of FIG. 9B. This up and down pivoting is represented by arrow B in FIG. 9C. Once in the upper horizontal position, the ramp section 102 may be moved back into the support structure 200 as represented by arrow A.

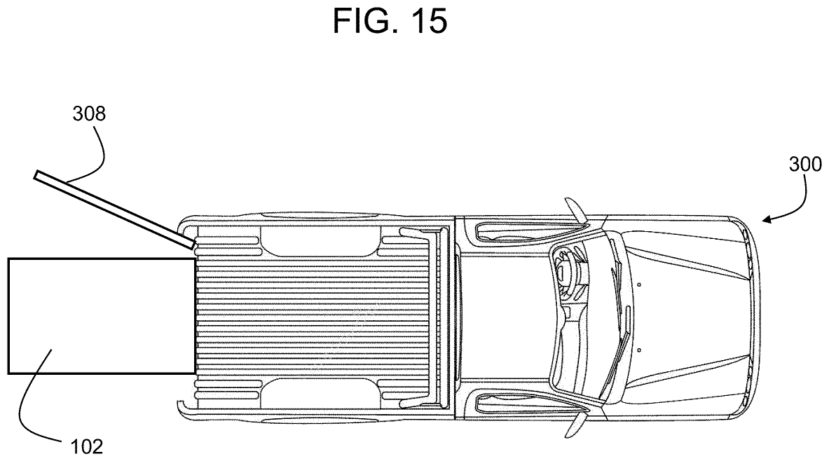

In one embodiment as shown in FIG. 10A, the ramp section 102 includes a stop 108 on its back end that prevents the ramp section 102 from being completely removed from the support structure 200. Note that the stop 108 also may be configured with the ramp section's left side 107, right side 109, top 103 bottom 105, and/or back 113, and/or in any combination thereof. The stop 108 may also allow for the ramp section 102 to rotate downward (pivot) as shown. In some embodiments, the stop 108 includes a downward pointing rim 110 adapted to engage an upward pointing lip 215 configured at the front 214 of the support structure 200. In other embodiments, one or more stops 108 include side pins (e.g., configured with the section's left side and/or right side and adapted to engage a left side 210 and/or a right side 212 of the support structure 200. Other types of stops also may be used.

In another embodiment as shown in FIG. 10B, the ramp section 102 includes a pivotable back portion 112 configured to remain generally within the support structure 200 while allowing the front portion (the ramp portion) of the ramp section 102 to rotate downward and deployed as a ramp. The pivotable back portion 112 may be configured with the front ramp section 102 using a pivot mechanism 114 such as a hinge, bearings, other types of pivot mechanisms, and any combination thereof.

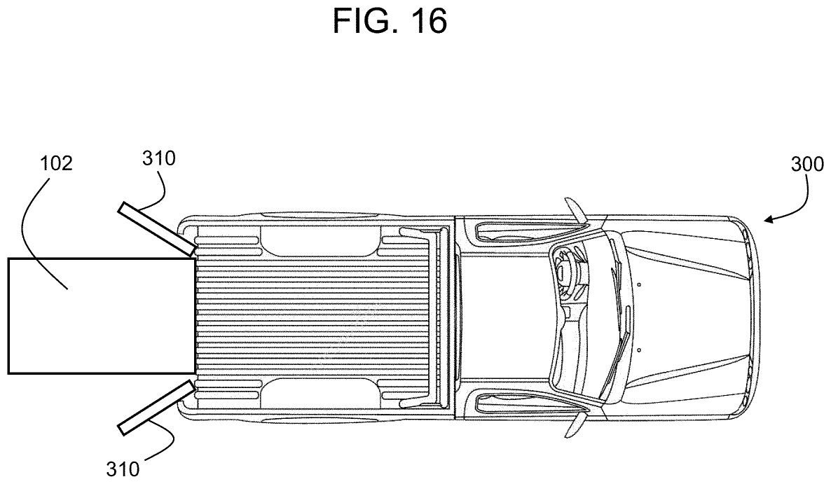

FIGS. 11-13 show an example pickup truck with the truck bed removed to expose the truck's chassis 302 for reference.

In one exemplary embodiment hereof as shown in FIGS. 11-13, the support structure 200 is configured with the chassis 302 of a truck 300. In one embodiment as shown in FIG. 11, the support structure 200 is configured with the top of the chassis 302.

In another embodiment as shown in FIG. 12, the support structure 200 is configured with the bottom of the chassis 302. In another embodiment as shown in FIG. 13, the support structure 200 is configured within the chassis 302 (e.g., between the chassis' left frame structure 304 and right frame structure 306). It is understood however that any portion(s) of the support structure 200 may be configured with any portion(s) of the chassis 302. That is, some portions of the support structure 200 may or may not be configured with the top of the chassis 302, some portions of the support structure 200 may or may not be configured with the bottom of the chassis 302 and some portions of the support structure 200 may or may not be configured within the chassis 302.

In some embodiments, the support structure 200 may be secured to the chassis 302 using bolts, clamps, welding, other types of attachment mechanisms, and any combination thereof. In some embodiments, the support structure 200 may be removably attached so that the support structure 200 may be removed from the truck 300 and reinstalled back onto the truck 300 when desired. In other embodiments, the support structure 200 is fixedly attached to the truck 300 and not removed.

In some embodiments, a first portion of the support structure 200 is fixedly attached to the truck 300 and may not be removed, and a second portion of the support structure 200 is removable from the first portion. The second (removable) portion may include a portion of the support structure 200 that houses and contains the ramp section 102 so that the removal of the second portion also removes the ramp section 102. The first portion (the portion that remains attached to the truck at all times) may include detachable attachment mechanisms (e.g., latches, locks, bolts, etc.) that may attach, detach, and subsequently reattach the second portion of the support structure 200 to the truck 300. In this way, the ramp section 102 may be removed from the truck 300 (along with the second portion of the support structure 200) and subsequently reattached to the truck 300 as desired.

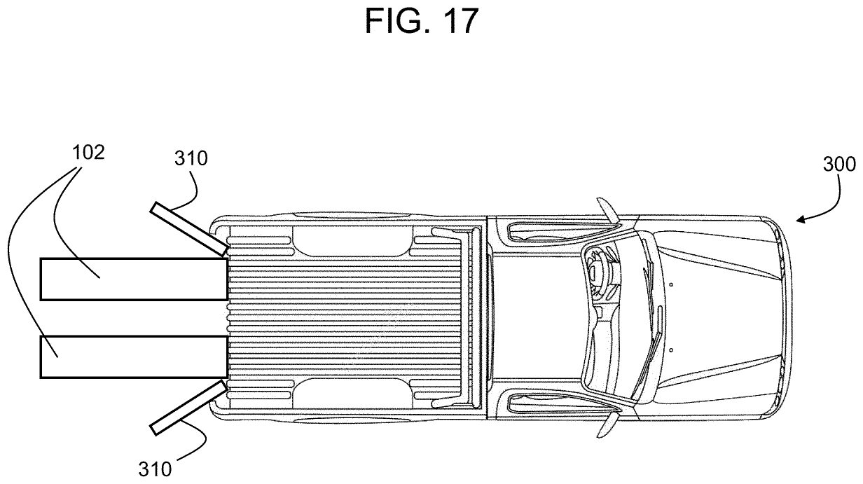

FIG. 14 shows the ramp section 102 deployed from the support structure 200 and configured as a ramp to load and/or unload items from the bed of the truck 300.

FIG. 15 shows a swing-away style tailgate 308 that may be used with the system 10 to allow access and deployment of the ramp section 102 and its subsequent use as a ramp to load and/or unload items into the bed of the truck 300.

FIG. 16 shows a split style tailgate 310 (double doors) that opens in the middle with the left and right sides swinging open outwardly. This may allow access and deployment of the ramp section 102 and its subsequent use as a ramp to load and/or unload items into the bed of the truck 300.

FIG. 17 shows a two-portion ramp section 102 comprising two side-by-side ramp sections that together form the ramp section 102. The truck includes a split style tailgate 310 (double doors) that opens in the middle with the left and right sides swinging open outwardly. This may allow access and deployment of the ramp section 102 and its subsequent use as a ramp to load and/or unload items into the bed of the truck.

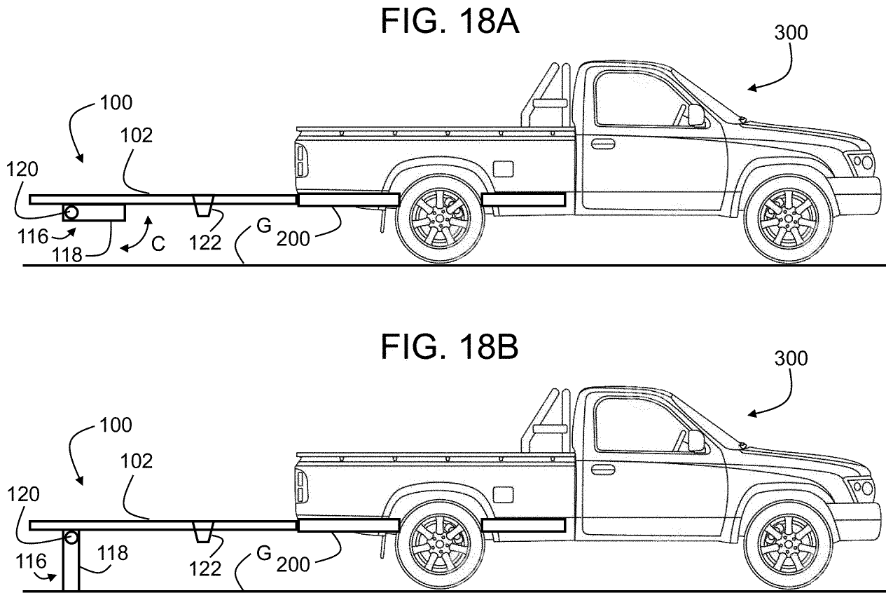

In some embodiments as shown in FIGS. 18A and 18B, the ramp structure 100, when at least partially deployed, is configurable for use as a table or other type of platform. In some embodiments, the ramp structure 100 includes a leg support assembly 116 configured with the ramp section(s) 102 that may be deployed to provide support between the ramp structure 100 and the ground G as shown. In this way, the leg support assembly 116 may support the ramp structure 102 in a substantially horizontal configuration so that the ramp structure 102 may serve as a tabletop, a seat, or other type of platform. For the purposes of this specification, the term substantially horizontal will mean horizontal +/−10°.

In some embodiments, the leg support assembly 116 includes one or more legs 118 that may be transitioned from a generally retracted position to a generally deployed position. In one example of this, the legs 118 may be configured with the ramp section 102 using a rotational mechanism 120 (e.g., a hinge, a ball joint, a pivot mechanism, etc.) so that the legs 118 may pivot about the rotational mechanism 120 between an upper position (e.g., generally horizontal) and a lower position (generally vertical) in the direction of arrow C. It may be preferable that when the legs 118 are deployed to the lower position that the ramp section 102 be supported by the legs 118 in a stable and generally horizontal position, and that when the legs 118 are retracted to the upper position, that the legs 118 are configured in a way that they do not obstruct or otherwise interfere with the other functionalities of the overall ramp system 10 (e.g., the legs 118 do not interfere with the deployment and/or usage of the ramp structure 100 as a ramp). It also may be preferable that when the legs 118 are in the upper and/or lower positions that the legs 118 are releasably held in position by latches, detents, locking pins, and/or by other suitable locking mechanisms.

It is understood that the example described above is meant for demonstration and that the legs 118 may be deployed for use and subsequently retracted for storage using other techniques. In one example, the legs 118 may rotate downward in other orientations or in other directions. In another example, the legs 118 may be deployed vertically or from a different direction. In another example, the legs 118 may comprise one or more leg sections that may fold upon one another. It also may be preferable that the legs 118 include additional support arms extending between adjacent legs 118 and/or between the legs 118 and the ramp structure 100. Any number of legs 118 may be used.

Note that the ramp section 102 may be fully or partially deployed depending on the length of the ramp section 102 that is desired for use as a table or other type of platform.

In some embodiments as shown in FIGS. 18A and 18B, the ramp section 102 may include accessory elements 122 such as cup holders, plate holders, padded seat holders, and/or other type of elements or accessories. In this way, the ramp section 102 may be deployed for use as a serving and dining table (e.g., for use at a tailgate party or barbeque), as a padded seat arrangement, or for other purposes. It may be preferable that the accessory elements 122 not interfere with the usage of the ramp section 102 as a ramp. For example, it may be preferable that the accessory elements 122 be flush with the top surface of the ramp section 102, or that if the elements 122 extend above the top surface of the ramp section 102 that they do not extend an amount that may interfere with the use of the ramp section 102 as a ramp. It also may be preferable that the accessory elements 122 be integrated with the ramp section 102 using the same or similar materials so that the elements 122 may withstand forces that may be applied to them when the ramp section 102 may be used as a ramp.

In some embodiments, the accessory elements 122 may be configured with a side of the ramp section 102 (e.g., the left side 107 and/or the right side 109). In some embodiments, the accessory elements 122 may be removable and/or attachable to the ramp section 102 using hooks, latches, or other releasable attachment mechanisms.

It is understood that any aspect(s) or element(s) of any embodiment(s) as described herein may be combined with any aspect(s) or element(s) of any other embodiment(s) in any way to form one or more embodiments that also are within the scope of the ramp system 10.

Those of ordinary skill in the art will appreciate and understand, upon reading this description, that embodiments hereof may provide different and/or other advantages, and that not all embodiments or implementations need have all advantages.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs,” and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X.” In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only,” the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A),” “(B),” “(C),” and so on, or “(a),” “(b),” and so on) and/or numbers (e.g., “(i),” “(ii),” and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise,” “including”, “having,” “contain,” and their variations should be understood as meaning “including but not limited to,” and are not intended to exclude other components unless specifically so stated.

It will be appreciated that variations to the embodiments of the invention can be made while still falling within the scope of the invention. Alternative features serving the same, equivalent, or similar purpose can replace features disclosed in the specification unless stated otherwise. Thus, unless stated otherwise, each feature disclosed represents one example of a generic series of equivalent or similar features.

The present invention also covers the exact terms, features, values, and ranges, etc. in case these terms, features, values and ranges etc. are used in conjunction with terms such as about, around, generally, substantially, essentially, at least, etc. (i.e., “about 3” shall also cover exactly 3 or “substantially constant” shall also cover exactly constant).

Use of exemplary language, such as “for instance,” “such as,” “for example,” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. A ramp system for use with a vehicle, the ramp system comprising:
a ramp support structure configured with the vehicle and including at least one open end;
a ramp structure including a front and a back, the ramp structure slidably configured with the ramp support structure;
a pivot mechanism configured to provide support to the back of the ramp structure at the at least one open end; and
a stop configured to obstruct the back of the ramp structure from being completely removed from the at least one open end;
wherein the front of the ramp structure is adapted to transition from a first position to a second position, the front extending outward from the at least one open end in the second position.

2. The ramp system of claim 1 wherein the front of the ramp structure is adapted to transition from the second position to a third position, wherein the third position is below the second position.

3. The ramp system of claim 1 wherein the vehicle includes a chassis, and the ramp support structure is configured with the chassis.

4. The ramp system of claim 3 wherein the ramp support structure is configured above the chassis, beneath the chassis, and/or between a left and right side of the chassis.

5. The ramp system of claim 1 wherein the vehicle includes a truck with a truck bed, and the ramp support structure is configured above the truck bed.

6. The ramp system of claim 1 further comprising at least one movement mechanism configured between the ramp support structure and the ramp structure.

7. The ramp system of claim 1 further comprising at least one leg configured with the ramp structure and adapted to support the ramp structure in a substantially horizontal position when the front of the ramp structure is in the second position.

8. The ramp system of claim 1 further comprising at least one of a cup holder, a plate holder, and a seat holder.

9. The ramp system of claim 8 wherein the at least one of a cup holder, a plate holder, and a seat holder is configured with a top surface of the ramp structure.

10. The ramp system of claim 8 wherein the at least one of a cup holder, a plate holder, and a seat holder is configured with a side of the ramp structure.

11. The ramp system of claim 8 wherein the at least one of a cup holder, a plate holder, and a seat holder is removable.

12. A ramp system for use with a truck with a chassis and a truck bed, the ramp system comprising:
a ramp support structure configured with the truck and including at least one open end facing outward from the truck bed;
a ramp structure including a front and a back, the ramp structure slidably configured with the ramp support structure;
a pivot mechanism configured to provide support to the back of the ramp structure at the at least one open end; and
a stop configured to obstruct the back of the ramp structure from being completely removed from the at least one open end;
wherein the ramp structure is adapted to transition from a first position wherein the majority of the ramp structure is contained by the ramp support structure to a second position wherein the majority of the ramp support structure is outside the ramp support structure.

13. The ramp system of claim 12 wherein the front of the ramp structure is adapted to transition from the second position to a third position, wherein the third position is below the second position.

14. The ramp system of claim 12 wherein the vehicle includes a chassis, and the ramp support structure is configured with the chassis.

15. The ramp system of claim 14 wherein the ramp support structure is configured above the chassis, beneath the chassis, and/or between a left and right side of the chassis.

16. The ramp system of claim 12 wherein the vehicle includes a truck with a truck bed, and the ramp support structure is configured above the truck bed.

17. The ramp system of claim 12 further comprising at least one movement mechanism configured between the ramp support structure and the ramp structure.

18. The ramp system of claim 12 further comprising at least one leg configured with the ramp structure and adapted to support the ramp structure in a substantially horizontal position when the front of the ramp structure is in the second position.

19. The ramp system of claim 1 further comprising at least one of a cup holder, a plate holder, and a seat holder.

20. The ramp system of claim 8 wherein the at least one of a cup holder, a plate holder, and a seat holder is configured with a top surface and/or a side of the ramp structure.
